(19) United States
(12) Patent Application Publication
(10) Pub. No.: US 2007/0159594 A9
(43) Pub. Date: Jul. 12, 2007

(54) Photochromic blue light filtering materials and ophthalmic devices

(76) Inventors: Dharmendra M. Jani, Fairport, NY (US); Jay F. Kunzler, Canandaigua, NY (US); Joseph C. Salamone, Fairport, NY (US)

Correspondence Address: Bausch & Lomb Incorporated, One Bausch & Lomb Place, Rochester, NY, 14604-2701, US

(21) Appl. No.: 11/121,960

(22) Filed: May 4, 2005

(51) Int. Cl. G02C 7/04; G02C 7/10

(52) U.S. Cl. 351/160 R

(57) ABSTRACT

Polymeric compositions have photochromic and blue-light filtering ability and are useful in the manufacture of ophthalmic medical devices. The polymeric compositions comprise a photochromic material incorporated into polymeric host materials and are activatable by blue light having a first wavelength range to become photochromic, and are thereby capable of absorbing blue light in a second wavelength range. Methods of making the compositions comprise incorporating a photochromic material into a polymeric host material.

### BACKGROUND OF THE INVENTION

The present invention relates to photochromic blue light and optionally ultraviolet (UV) light filtering polymers. In particular, this invention also relates to such polymers having light filtering capability that is radiation exposure dependent. More particularly, this invention also relates to ophthalmic medical devices made from such polymers.

Since the 1940s optical devices in the form of intraocular lens (IOL) implants have been utilized as replacements for diseased or damaged natural ocular lenses. In most cases, an intraocular lens is implanted within an eye at the time of surgically removing the diseased or damaged natural lens, for example, in the case of cataracts. For decades, the preferred material for fabricating such intraocular lens implants was poly(methyl methacrylate), which is a rigid, glassy polymer.

Softer, more flexible IOL implants have gained in popularity in more recent years due to their ability to be compressed, folded, rolled or otherwise deformed. Such softer IOL implants may be deformed prior to insertion thereof through an incision in the cornea of an eye. Following insertion of the IOL in an eye, the IOL returns to its original pre-deformed shape due to the memory characteristics of the soft material. Softer, more flexible IOL implants as just described may be implanted into an eye through an incision that is much smaller, i.e., less than 4.0 mm, than that necessary for more rigid IOLs, i.e., 5.5 to 7.0 mm. A larger incision is necessary for more rigid IOL implants because the lens must be inserted through an incision in the cornea slightly larger than the diameter of the inflexible IOL optic portion. Accordingly, more rigid IOL implants have become less popular in the market since larger incisions have been found to be associated with an increased incidence of postoperative complications, such as induced astigmatism.

With recent advances in small-incision cataract surgery, increased emphasis has been placed on developing soft, foldable materials suitable for use in artificial IOL implants. Mazzocco, U.S. Pat. No. 4,573,998, discloses a deformable intraocular lens that can be rolled, folded or stretched to fit through a relatively small incision. The deformable lens is inserted while it is held in its distorted configuration, then released inside the chamber of the eye, whereupon the elastic property of the lens causes it to resume its molded shape. As suitable materials for the deformable lens, Mazzocco discloses polyurethane elastomers, silicone elastomers, hydrogel polymer compounds, organic or synthetic gel compounds and combinations thereof.

A significant portion of the non-ionizing electromagnetic radiation emanating from the sun includes ultraviolet-A (UV-A), ultraviolet-B (UV-B) and ultraviolet-C (UV-C) (200 to 400 nanometers wavelength), visible (400 to 770 nanometers) and infrared (770 nanometers to 1 millimeter) ranges. Such non-ionizing electromagnetic radiation is potentially harmful to the structural components of the eye, especially to the retina, through thermal and photochemical processes. With the exception of the cornea of an eye, which is exposed to all atmospheric radiation, each segment of the eye is progressively and selectively protected by the absorbing action of preceding tissues. The eye thereby exhibits a filtering system consisting of a consecutive series of filters, which ultimately protect the retina against the harmful effects of certain radiation wavelengths. As a result, the adult human retina is exposed exclusively to radiation wavelengths between 400 and 1400 nanometers. All remaining incident radiation outside the 400 to 1400 nanometer range is absorbed by the cornea, aqueous humor, crystalline lens and vitreous body.

An essential component of an eye's light filtering system is the lens. After age twenty, the lens absorbs most of the ultraviolet radiation between 320 and 400 nanometers, a range known as UV-A. Absorption is enhanced and is shifted to longer wavelengths and eventually expands over the whole visible range as the lens ages. This enhanced absorption correlates with the natural production of fluorescent chromophores in the lens and the lens' age-dependent increase in chromophore concentration. Concomitantly, the lens takes on a yellow hue due to generation of certain pigments through continuous photodegradation of molecules that absorb in the UV-A range.

The damaging effects of intense natural light to the retina, especially that of long-wavelength ultraviolet radiation (UV-A, 320-400 nanometers) and short-wavelength visible radiation (400 to 510 nanometers) were noticed some time ago. Acute ultraviolet hazards apply when the eye is exposed to excessive amounts of radiation. Such hazards are well recognized in certain industrial environments and are prevented through the use of regulated or standardized protection equipment. Similarly, the eye is protected from acute injury of the visible radiation by involuntary aversion reflexes of the eye itself, as blinking. However, more subtle photochemical effects induced by daily exposure to relatively low levels of UV-A radiation and visible radiation at the violet/blue end of the spectrum have been appreciated recently and are of greater concern. The retina is very vulnerable to UV-A radiation and the damage inflicted is extensive, as demonstrated on experimental animals. The sensitivity of the retina to short-wavelength visible radiation, known as “blue light hazard range” is lower but this radiation is ubiquitous and reaches the eye unhampered throughout life. Both UV-A radiation and blue light are linked with age-related macular degeneration of the retina. Experimental evidence, at least for the blue light hazard range, is compelling. Accordingly, specialists recommend adequate protection by filtering off as much as possible radiation in the range of 320 to 510 nanometers. This is precisely the work performed by the adult natural lens as part of the filtering system of the eye. In the aphakic eye where the natural lens has been removed, the most important filter in this system is removed and the age-compromised retina is suddenly exposed to a large dose of harmful radiation.

Thus, any artificial ocular device intended to act as a substitute for the natural lens should have filtering properties as close to those of the natural lens as possible. Several materials have been invented that are capable of filtering blue light. But these materials are shown to be activatable by UV radiation, and thus are not useful when incident light lacks the UV component. Therefore, there is a continued need for photochromic materials that are activatable by blue light. It is also very desirable to produce compositions comprising such photochromic materials for the manufacture of ophthalmic devices such as intraocular lenses, corneal inlays, contact lenses, and like medical devices.

### SUMMARY OF THE INVENTION

In general, the present invention provides polymers having photochromic property and being capable of filtering at least a portion of blue light incident thereon. The photochromic property of a polymer of the present invention is activated at least by light having wavelengths in the blue range; i.e., from about 400 nm to about 500 nm. Upon being activated, the polymer also absorbs, thus filters out, a portion of incident light having different wavelengths in the blue range. In one aspect, the polymer also is capable of filtering at least a portion of UV radiation (i.e., radiation having wavelengths in the range from about 180 nm to about 400 nm) incident thereon.

In another aspect, the photochromic and filtering capability of the polymer is radiation exposure dependent, particularly wavelength dependent.

In still another aspect, a polymer of the present invention comprises a copolymer of a material selected from the group consisting of polymerizable monomers, oligomers, prepolymers, macromolecular monomers, and combinations thereof, in combination with at least one photochromic polymerizable material having blue light-absorbing capability. The polymer can also include a UV absorbing material.

In still another aspect, the present invention also provides ophthalmic medical devices comprising a polymer that is photochromic and capable of filtering at least a portion of blue light incident thereon. Photochromic polymers of the present invention have at least a desirable property such as being transparent, having relatively high elongation, and having relatively high refractive index. They are suitable for use in the manufacture of ophthalmic devices such as intraocular lens (IOL) implants, contact lenses, keratoprostheses, corneal rings, corneal inlays, and the like.

In still another aspect, the present invention provides a process for the production of biocompatible photochromic polymeric compositions that absorb blue light and have desirable physical characteristics suitable for use in the manufacture of ophthalmic devices.

Other features and advantages of the present invention will become apparent from the following detailed description and claims.

### BRIEF DESCRIPTION OF THE DRAWINGS

FIG. 1 shows the emission spectrum of the blue light source used to activate samples of photochromic polymeric compositions.

FIG. 2 shows transmission spectra of a sample made according to the procedure of Example 2, in an unactivated state, after 1 minute of exposure to the blue light source of FIG. 1, and after 1, 2, and 3 minutes after the blue light source has been removed.

FIG. 3 shows the transmission spectrum of an IOL made according to Example 8.

### DETAILED DESCRIPTION OF THE INVENTION

In general, the present invention provides polymers that are photochromic and are capable of filtering at least a portion of blue light incident thereon. The photochromic and light-filtering property of the polymers is activated at least by light having wavelengths in the blue range; i.e., from about 400 nm to about 500 nm.

In one aspect, the present invention also provides photochromic ophthalmic medical devices comprising such photochromic polymers. These devices can prevent or at least retard the development of age-related macular degeneration through the slowing or prevention of the formation of drusen believed to be triggered by exposure to blue light and/or ultraviolet radiation. Non-limiting examples of ophthalmic medical devices of the present invention include intraocular lenses (IOLs), contact lenses, corneal inlays, and the like.

Photochromism is the reversible transformation of a chemical species induced by suitable electromagnetic radiation between two states showing different absorption spectra. The chemical species in the second state upon absorption of the suitable electromagnetic radiation is commonly referred to as being activated. A material capable of undergoing photochromism is referred to as a photochromic material. Due to the different absorption spectra in the two states, a photochromic material exhibits a change in color upon activation. Existing photochromic compounds that have been used for ophthalmic medical devices have been shown to be activated by only radiation having wavelengths in the UV-A region (from about 320 nm to less than about 400 nm). Thus, these existing materials are not useful in lighting conditions that lack the UV-A component because they cannot be activated. However, as pointed out above, blue light still can be hazardous to the eye and should be attenuated. Therefore, the present invention represents an advance over the prior art in the quest for materials to satisfy this need by providing photochromic compositions for use in ophthalmic medical devices, which compositions, in an unactivated state, have a predominant absorption in a wavelength range from about 300 nm to about 500 nm at the physiological temperature range (e.g., from about 35° C. to about 38° C.). Such predominant absorption can be exhibited by a peak in the absorption spectrum or represented by a major portion of all the radiation energy absorbed by the material over the entire range from about 300 nm to about 770 nm. Depending on the chosen composition used to make ophthalmic devices, a suitable photochromic material of the composition can have a predominant absorption in the activated state in the UV range (i.e., from about 300 nm to about 400 nm), or in a portion of the blue range (i.e., from about 400 nm to about 500 nm), or both. A polymeric composition of the present invention can include two or more photochromic materials having predominant absorption in the activated state in different wavelength ranges to achieve a desired total absorption range. Upon exposure to radiation having wavelengths in the range from about 380 nm to about 500 nm, preferably from about 400 nm to about 480 nm, and more preferably from about 400 nm to about 460 nm, suitable photochromic materials for use in the present invention change substantially quickly from the unactivated state to the activated state. Upon removal of the radiation source, the materials also change substantially quickly from the activated state to the unactivated state. Optionally, upon exposure to radiation having wavelengths in the range from about 500 nm to about 770 nm, preferably from about 550 nm to about 700 nm, suitable photochromic materials for use in the present invention change substantially quickly from the activated state to the unactivated state. In one aspect, change from the unactivated state to the activated state occurs in a time range from about 1 second to about 10 minutes, preferably in about 1 second to about 5 minutes, and more preferably in about 1 second to about 1 minute, at a temperature in the range from about 25° C. to about 40° C. to minimize visual impairment upon an abrupt change in lighting conditions. The photochromic composition reaches the activated state when the transmission spectrum does not change noticeably for one minute. In another aspect, the bleach rate (T_{1/2}) of a photochromic composition of the present invention is in the range from about 1 second to about 10 minutes, preferably from about 1 second to about 5 minutes, and more preferably from about 1 second to about 1 minute, at a temperature in the range from about 25° C. to about 40° C. The bleach rate is the time for the highest absorbance of the activated state of the photochromic composition to reach one-half of that absorbance, at a temperature in the range from about 25° C. to about 40° C., after removal of the activating radiation source.

Photochromic materials useful in the manufacture of optical implants desirably exhibit low fatigue. Fatigue is the gradual diminishing of the photochromic response as the material is repeatedly cycled between the unactivated state (lower color intensity) and the activated state (higher color intensity). Desirable materials for the manufacture of IOLs are capable of thousands of cycles over the life of the implant with relatively low fatigue.

Non-limiting examples of suitable photochromic materials for use in the present invention include organic materials or inorganic materials which undergo heterolytic cleavage, hemolytic cleavage, cis-trans isomerization, photoinduced tautomerism, or activation to triplet states. Examples of such photochromic materials can include, but are not limited to, the following classes of materials: chromenes, e.g., naphthopyrans, benzopyrans, indenonaphthopyrans, phenanthropyrans, anthracene-fused pyrans, and tetracene-fused pyrans; spiropyrans, e.g., spiro(benzindoline)naphthopyrans, spiro(indoline)benzopyrans, spiro(indoline)naphthopyrans, spiro(indoline)quinopyrans and spiro(indoline)pyrans; oxazines, e.g., spiro(indoline)naphthoxazines, spiro(indoline)pyridobenzoxazines, spiro(benzindoline)pyridobenzoxazines, spiro(benzindoline)naphthoxazines and spiro(indoline)benzoxazines; mercury dithizonates, fulgides, fulgimides, derivatives thereof, and combinations thereof. The syntheses of spirobenzopyrans, spironaphthoxazines, benzopyrans, naphthopyrans, fulgides and their derivatives or related compounds including fulgimides, and diarylethenes are taught in “Chromic Phenomena: Technological Applications of Colour Chemistry,” by P. Bamfield, RSC Books (2001). Derivatives of these compounds that include various substituents can be synthesized from this teaching by people skilled in the art. The syntheses of various specific compounds are also taught, for example, in the following U.S. Pat. Nos.: 5,458,814; 5,514,817; 5,573,712; 5,645,767; 5,656,206; 5,698,141; 5,723,072; 5,869,658; 5,955,520; 5,961,892; 6,018,059; 6,022,497; 6,113,814; 6,146,554; 6,153,126; 6,248,264; 6,296,785; 6,315,928; 6,342,459; 6,348,604; and 6,353,102. These patents are incorporated herein by reference in their entirety.

Preferred photochromic materials for use in ophthalmic devices include the naphthopyrans, indenonaphthopyrans, and their derivatives based on 2H-napthopyrans and 3H-napthopyrans that undergo heterolytic cleavage without complete fragmentation of the molecule and exhibit relatively low fatigue. These materials in the activated state typically exhibit a significant absorption in the blue light range.

Non-limiting examples of the 2H-naphthopyran compounds within the scope of the invention include the following: 2,2-diphenyl-5-hydroxy-6-carboethoxy-2H-naphtho[1,2-b]pyran; 2,2-diphenyl-5-methoxy-6-carboethoxy-2H-naphtho[1,2-b]pyran; 2,2-diphenyl-5-hydroxy-6-morpholinocarbonyl-2H-naphtho[1,2-b]pyran; 2,2-diphenyl-5-morpholino-6-carboethoxy-2H-naphtho[1,2-b]pyran; 2,2,5-triphenyl-6-carboethoxy-2H-naphtho[1,2-b]pyran; 2-(4-methoxyphenyl)-2-(4-morpholinophenyl)-5-hydroxy-6-carboethoxy-2H-naphtho[1,2-b]pyran; 2,2-diphenyl-5-hydroxy-6-carbomethoxy-9-methoxy-2H-naphtho[1,2-b]pyran; 2-(4-methoxyphenyl)-2-phenyl-5-morpholino-6-carbomethoxy-9-methoxy-2H-naphtho[1,2-b]pyran; 2-(4-methoxyphenyl)-2-phenyl-5-morpholino-6-carbomethoxy-9-methyl-2H-naphtho[1,2-b]pyran; derivatives thereof; and combinations thereof.

Non-limiting examples of the 3H-naphthopyran compounds within the scope of the invention include the following: 3,3-diphenyl-3H-naphtho[2,1,b]pyran; 3-phenyl-3-(4-methoxyphenyl)-3H-naphtho[2,1,b]pyran; 3-phenyl-3-(4-trifluoromethylphenyl)-3H-naphtho[2,1,b]pyran; 3,3-di(4-methoxyphenyl)-3H-naphtho[2,1,b]pyran; 3-(4-methoxyphenyl)-3-(4-trifluoromethylphenyl)-3H-naphtho[2,1,b]pyran; 3,3-di(4-methoxyphenyl)-6-piperidino-3H-naphtho[2,1,b]pyran; 3,3-di(4-methoxyphenyl)-6-morpholino-3H-naphtho[2,1,b]pyran; derivatives thereof; and combinations thereof.

In one aspect, the photochromic compound has at least one reactive functional group that can form a bond with a complementary reactive group on a precursor of the polymer. In one embodiment, the bond is covalent. In another embodiment, the complementary reactive group is on a pendant group of the precursor of the polymer. Thus, the photochromic compound can be incorporated into the polymer to produce the photochromic, blue light-filtering polymer. In still another embodiment, the photochromic compound has at least two reactive functional groups and the polymer precursor has two complementary terminal reactive groups so that the photochromic compound can be inserted along the chain of the final polymer.

In another aspect, the reactive functional group in the photochromic compound is a part of a substituent on a cyclic group, or is attached thereto through a linking group. Non-limiting examples of a divalent linking group include groups chosen from linear or branched chain C₁-C₂₀ alkylene, linear or branched chain C₁-C₄ polyoxyalkylene, cyclic C₃-C₂₀ alkylene, phenylene, naphthylene, C₁-C₄ alkyl substituted phenylene, mono- or poly-urethane(C₁-C₂₀)alkylene, mono- or poly-ester(C₁-C₂₀)alkylene, mono- or poly-carbonate(C₁-C₂₀)alkylene, polysilane, polysiloxane or a mixture thereof. The number of divalent linking groups can vary widely. In one non-limiting embodiment, there can be from 1 to 100 groups, or any number within this range. In one embodiment, the divalent linking group is selected from the group consisting of alkylene, and poly(C₁-C₄ alkyleneoxy) groups having 1 to, and including, 10 carbon atoms. Other linking groups also are suitable and are within the scope of this disclosure when they do not adversely affect the photochromic and blue-light filtering property of the parent photochromic compound.

Non-limiting examples of reactive functional groups are vinyl, allyl, acryloyl, acryloyloxy, methacryloyl, methacryloyloxy, acrylamido, methacrylamido, itaconoyl, fumaroyl, maleimido, epoxide, isocyante, amino, hydroxy, alkoxy, mercapto, anhydride, carboxylic, and combinations thereof. Specific non-limiting examples of the photochromic compounds of the present invention are the 2-H and 3-H naphthopyrans disclosed above wherein a vinyl, acryloyl, or methacryloyl functional group is attached to a benzene ring of the naphthalene group of the naphthopyran. In one embodiment, such acryloyl or methacryloyl functional group is attached to such benzene ring through an alkylene or alkyleneoxy linking group having 1 to, and including, 10 carbon atoms.

In one contemplated non-limiting embodiment, the polymeric organic host material into which a photochromic, blue light-filtering compound can be incorporated, can be a solid transparent or optically clear material, e.g., materials having a luminous transmittance of at least 70 percent (preferably at least 90 percent, and more preferably at least 95 percent), and are suitable for optical applications, such as ophthalmic lenses, or ocular devices such as ophthalmic devices that physically reside in or on the eye, e.g., contact lenses and intraocular lenses.

Non-limiting examples of polymeric organic materials which can be used as a host material into which a photochromic, blue light-filtering compound can be incorporated include polymers, oligomers, and prepolymers, such as polysiloxanes (including polysiloxane prepolymers end-capped with reactive functional groups such as acryloyl or methacryloyl), silicone hydrogels, fluorosilicone hydrogels, polyacrylamides, polymethacrylamides, polycarbonates, polycarbamates, fluoropolymers, polyolefins, polyacrylates, polymethacrylates, poly(acrylic acid), poly(methacrylic acid), polyurethanes, polythiourethanes, thermoplastic polycarbonates, polyesters, poly(ethylene terephthalate), polystyrene, poly(a-methylstyrene), copoly(styrene-methyl methacrylate), copoly(styrene-acrylonitrile), polyvinylbutyral, poly(vinyl acetate), cellulose acetate, cellulose propionate, cellulose butyrate, cellulose acetate butyrate, copolymers thereof, mixtures thereof, and other polymers, such as homopolymers and copolymers prepared by polymerizing monomers chosen from bis(allyl carbonate) monomers, styrene monomers, diisopropenyl benzene monomers, vinylbenzene monomers, diallylidene pentaerythritol monomers, polyol (allyl carbonate) monomers (e.g., diethylene glycol bis(allyl carbonate)), vinyl acetate monomers, acrylonitrile monomers, monofunctional or polyfunctional (e.g., di- or multi-functional), (meth)acrylate monomers such as (C₁-C₁₂)alkyl (meth)acrylates (e.g., methyl (meth)acrylate, ethyl (meth)acrylate, butyl (meth)acrylate etc.), poly(oxyalkylene) (meth)acrylate, poly(alkoxylated phenol (meth)acrylates), diethylene glycol (meth)acrylates, ethoxylated bisphenol-A (meth)acrylates, ethylene glycol (meth)acrylates, poly(ethylene glycol) (meth)acrylates, ethoxylated phenol (meth)acrylates, alkoxylated polyhydric alcohol (meth)acrylates (e.g., ethoxylated trimethylol propane triacrylate monomers), urethane (meth)acrylate monomers, and mixtures thereof. The term “(meth)acrylate,” as used herein, means acrylate or methacrylate.

In another non-limiting embodiment, transparent copolymers and blends of transparent polymers are also suitable as polymeric materials.

Non-limiting preferred examples of polymers for optical applications include such thermoplastic resins as poly(methyl acrylate), poly(ethyl acrylate), poly(methyl methacrylate), poly(ethyl methacrylate), polystyrene, polyacrylonitrile, poly(vinyl alcohol), polyacrylamide, poly(2-hydroxyethyl methacrylate), polydimethylsiloxane and polycarbonate. There can be further exemplified multi-valent acrylic acids and multi-valent methacrylic acid ester compounds, such as ethylene glycol diacrylate, diethylene glycol dimethacrylate, triethylene glycol dimethacrylate, tetraethylene glycol dimethacrylate, ethylene glycol bisglycidyl methacrylate, bisphenol-A dimethacrylate, 2,2-bis(4-methacryloyloxyethoxyphenyl)propane, 2,2-bis(3,5-dibromo-4-methacryloyloxyethoxyphenyl)propane, trimethylolpropane trimethacrylate, and pentaerithritol tetramethacrylate; multivalent allyl compounds, such as diallyl phthalate, diallyl terephthalate, diallyl isophthalate, diallyl tartarate, diallyl epoxysuccinate, diallyl fumarate, diallyl chloroendoate, diallyl hexaphthalate, diallyl carbonate, and allyl diglycol carbonate; multivalent thioacrylic acid and multivalent thiomethacrylic acid ester compounds such as 1,2-bis(methacryloylthio)ethane, bis(2-acryloylthioethyl)ether, and 1,4-bis(methacryloylthiomethyl)benzene; acrylic acid ester compounds and methacrylic acid ester compounds, such as glycidyl acrylate, glycidyl methacrylate, β-methylglicidyl methacrylate, bisphenol A-monoglycidylether methacrylate, 4-glycidyloxy methacrylate, 3-(glicidyl-2-oxyethoxy)-2-hydroxypropyl methacrylate, 3-(glycidyloxy-1-isopropyloxy)-2-hydroxypropyl acrylate, 3-glycidyloxy-2-hydroxypropyloxy)-2-hydroxypropyl acrylate and methoxypolyethylene glycol methacrylate; and thermosetting resins obtained by polymerizing radically polymerizable polyfunctional monomers such as divinyl benzene and the like. There can be further exemplified copolymers of these monomers with unsaturated carboxylic acids such as acrylic acid, methacrylic acid and maleic anhydride; acrylic acid and methacrylic acid ester compounds such as methyl acrylate, methyl methacrylate, benzyl methacrylate, phenyl methacrylate, and 2-hydroxyethyl methacrylate, methyl ether polyethylene glycol methacrylate and γ-methacryloyloxypropyltrimethoxy silane; fumaric acid ester compounds such as diethyl fumarate and diphenyl fumarate; thioacrylic acid and thiomethacrylic acid ester compounds such as methylthio acrylate, benzylthio acrylate and benzylthio methacrylate; or radically polymerizable monofunctional monomers such as vinyl compounds like styrene, chlorostyrenes, methyl styrenes, vinyl naphthalene, bromostyrenes, and methoxypolyethylene glycol allyl ether.

In a further non-limiting embodiment, the monomers used to produce the organic polymeric material include monomers used to produce hydrogel polymers. A hydrogel is a crosslinked polymeric system that can absorb and retain water in an equilibrium state. Hydrogel polymers can be formed by polymerizing at least one hydrophilic monomer and at least one crosslinking agent (a crosslinking agent being defined herein as a monomer having multiple polymerizable functional groups of the same or different kinds). Representative hydrophilic monomers include: unsaturated carboxylic acids, such as methacrylic acid and acrylic acid; (meth)acrylic substituted alcohols, such as 2-hydroxyethyl methacrylate and 2-hydroxyethyl acrylate; vinyl lactams, such as N-vinyl pyrrolidone; and (meth)acrylamides, such as methacrylamide and N,N-dimethylacrylamide. Non-limiting examples of crosslinking agents include polyvinyl, typically di- or tri-vinyl monomers, such as di- or tri(meth)acrylates of diethyleneglycol, triethyleneglycol, butyleneglycol and hexane-1,6-diol; and divinylbenzene. A specific example of a hydrogel polymer-forming monomer mixture comprises primarily of 2-hydroxyethyl methacrylate with a small amount of diethyleneglycol dimethacrylate as a crosslinking monomer.

In a still further non-limiting embodiment, the polymerizable monomer mixture includes a siloxane-containing monomer in order to form a polysiloxane hydrogel polymer. A “siloxane-containing monomer” means, without limitation, a compound that contains at least one [—Si—O—] group in a monomer, macromonomer, or prepolymer. Non-limiting examples of siloxane-containing monomers include: monomers including a single activated unsaturated radical, such as 3-methacryloxypropyltris(trimethylsiloxy)silane, pentamethyldisiloxanyl methyl methacrylate, methyldi(trimethylsiloxy)methacryloxymethylsilane, 3-[tris(trimethylsiloxy)silyl]propyl vinylcarbamate, and 3-[tris(trimethylsiloxy)silyl]propylvinyl carbonate; and multifunctional ethylenically “end-capped” siloxane-containing monomers; e.g., difunctional monomers having two activated unsaturated radicals. An example of a polysiloxane hydrogel polymer-forming monomer mixture is based on N-vinylpyrrolidone and the aforementioned vinyl carbonate and carbamate monomers.

It is preferred that the monomers, oligomers, or prepolymers and the polymerization process do not substantially change the specific desired photochromic characteristics of the one or more chosen photochromic compounds in the final polymer.

One or more suitable polymerizable monomers, oligomers and/or prepolymers, in combination with one or more photochromic materials, may be polymerized to form polymeric compositions using various techniques, depending on the specific composition desired. In so doing, the amount of photochromic material in the composition can be easily controlled, depending on in the present case, the level of blue light absorption capability desired. In one embodiment, for use in the present invention, the composition absorbs about 25 to about 75 percent of blue light, preferably about 30 to about 65 percent of blue light, and more preferably about 45 to about 55 percent blue light, measured at the highest absorption in the wavelength range from about 400 nm to about 500 nm.

Embodiments of the present invention are described in still greater detail in the Examples provided below. Unless otherwise specified, the terms “parts,” as used in the following Examples, means parts by weight.

### EXAMPLE 1

### Synthesis of 3-Phenylpropyl Acrylate (PPA)

In a two-liter amber colored round bottom flask equipped with a mechanical stirrer, dropping funnel, thermometer, condenser, and nitrogen blanket were placed 50 g (0.37 mole) of 3-phenylpropanol, 41.5 g (0.41 mole) of triethylamine and 100 ml of ethyl acetate. The above was cooled to less than 0° C. The reaction was allowed to come to room temperature and stirred under nitrogen overnight. The following morning the organic layer was washed two times with 1 N HCl, one time with brine, and two times with 5% NaHCO₃. The organic layer was dried over MgSO₄, filtered and rotoevaporated to an oil, and passed through 200 g of silica gel eluting with 70/30 heptane/dichloromethane. After solvent removal, 48 g of 97% pure, by gas chromatograph, product resulted. The described synthesis of PPA is further illustrated in Scheme 1 below.

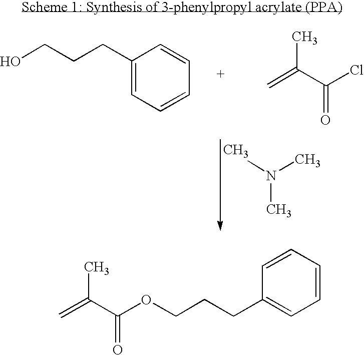

### EXAMPLE 2

### Film Preparation of Photochromic High Refractive Index Hydrophobic Acrylic Composition

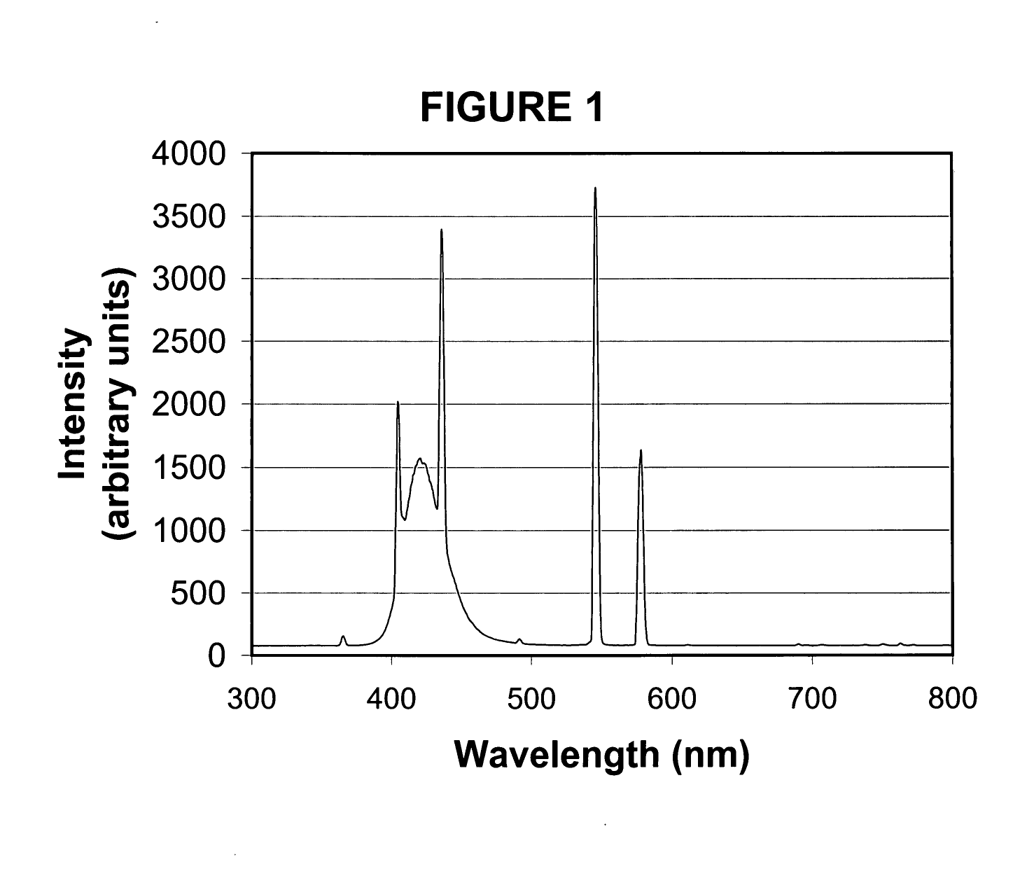

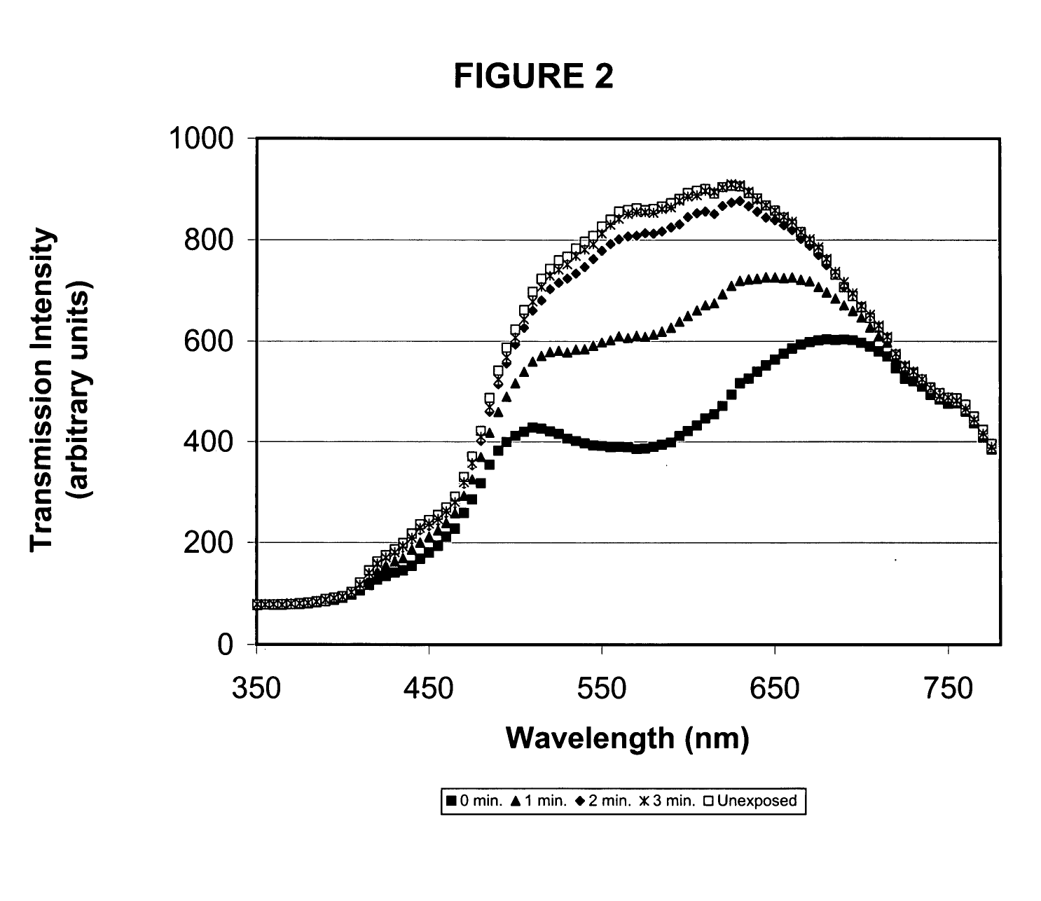

To 65 parts of PPA prepared in Example 1 were added 35 parts of dimethylacrylamide, 20 parts of methyl methacrylate, 3 parts of ethylene glycol dimethacrylate, 0.5% Vazo® 64 (2,2′-azobisisobutyronitrile, available from DuPont Chemical, Wilmington, Del.) as the thermal polymerization initiator, and 0.5 mg/ml of a naphthopyran having a methacrylate reactive functional group. The clear solution was sandwiched between two silanized glass plates using metal gaskets and polymerized by heating at 60° C. for about 1 hour, 80° C. for about 1 hour, and 100° C. for about 1 hour. The resultant films were released and extracted in isopropanol (IPA) for four hours, followed by air-drying and a 30 mm vacuum to remove the IPA. The films were hydrated at room temperature overnight in borate buffered saline. The clear tack-free films possessed a modulus of 63 g/mm², a tear strength of 18 g/mm, a water content of 11.5% and a refractive index of 1.53. The films were exposed to a blue light source (the emission spectrum of which is shown in FIG. 1) for 1 minute, and then the blue light source was removed. The films were then immediately exposed to a broad spectrum visible light source. The film darkened after approximately one minute of blue light exposure (at about 32° C.) and returned to its substantially colorless state within about 4 minutes after the blue light source was removed. FIG. 2 shows the transmission spectrum of a specimen of the photochromic hydrophobic acrylic composition of this Example after exposure for 1 minute to the blue light source and at 1, 2, and 3 minutes under exposure to a broad spectrum visible light (after the 1-minute exposure to blue light). A comparison of the transmission spectrum of the unexposed material and the material after 1-minute exposure to blue light shows that the photochromic material incorporated into the PPA polymer was activated by the blue light having wavelengths in the range from about 400 nm to about 450 nm and, in its activated state, another portion of the blue light (having wavelengths in the range from about 400 nm to about 500 nm) was absorbed. This result was surprising in view of the fact that this naphthopyran compound itself without being incorporated into the polymer (for example, in a liquid solution) was not activatable by blue light in the wavelength range from about 400 nm to about 450 nm.

### EXAMPLE 3

### Synthesis of Methacryloyloxypropyl, 3,3-dimethyl-1,1,1-(triphenyl)disiloxane (MPTDS)

To a 1000 ml one-neck round bottom flask fitted with a magnetic stirrer, condenser, heating mantle and nitrogen blanket, are added 500 ml CHCl₃, 18.2 grams (149 mmole) of dimethylaminopyridine (DMAP), 37.6 grams (135.9 mmole) of triphenylsilanol and 30.0 grams (135.9 mmole) of 3-methacryloyloxypropyldimethylchlorosilane. The contents of the flask are refluxed for 72 hours and then allowed to cool to room temperature. The organics are washed twice in 500 ml 2N HCl, then dried over magnesium sulfate and flashed to an oil. After column chromatography on silica gel eluting with 80% heptane and 20% CH₂Cl₂, the product is isolated. The chromatography is monitored by thin layer chromatography (TLC) plates. The described synthesis of MPTDS is further illustrated in Scheme 2 below.

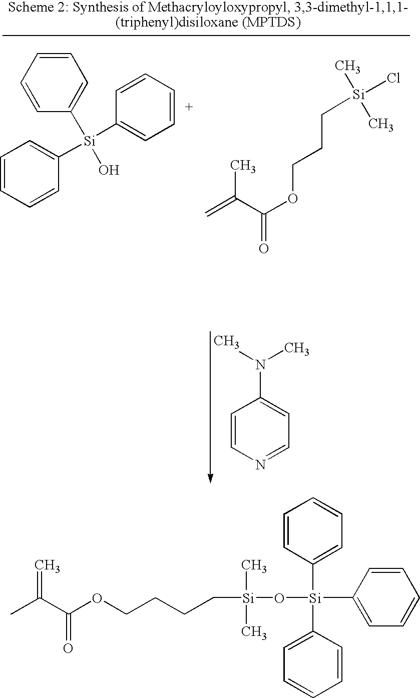

### EXAMPLE 4

### Film Preparation of Photochromic High Refractive Index Hydrophilic Acrylic Composition

To 64 parts of MPTDS prepared in Example 3 are added 33 parts of N,N-dimethylacrylamide, 20 parts of hexanol, 2 parts of ethylene glycol dimethacrylate, 0.5% Vazo® 64 (2,2′-azobisisobutyronitrile, available from DuPont Chemical, Wilmington, Del.) as the thermal polymerization initiator, and 0.5 mg/ml of the naphthopyran of Example 2. The clear solution is sandwiched between two silanized glass plates using metal gaskets and polymerized by heating at 60° C. for about 1 hour, 80° C. for about 1 hour, and 100° C. for about 1 hour. The resultant films are released and extracted in isopropanol (IPA) for four hours, followed by air-drying and a 30 mm vacuum to remove the IPA. The resultant films are hydrated at room temperature overnight in borate buffered saline. The films can be tested for their photochromic property in a similar manner as in Example 2.

### EXAMPLE 5

### Synthesis of a Methacrylate End-Capped Fluoro-Substituted Side-Chain Siloxane

To a 500 ml round bottom flask equipped with a magnetic stirrer and water condenser were added a methacrylate end capped silicone hydride (25 mole percent) containing silicone (15 g, 0.002 mole), allyloxyoctafluoropentane (27.2 g, 0.1 mole), tetramethyldisiloxane platinum complex (2.5 ml of a 10% solution in xylenes), 75 ml of anhydrous dioxane, and 150 ml of anhydrous tetrahydrofuran under a nitrogen blanket. The reaction mixture was heated to 75° C. and the reaction was monitored by IR and ¹H-NMR spectroscopy for loss of silicone hydride. The reaction was complete after 4 to 5 hours of reflux. The resulting solution was placed on a rotoevaporator to remove tetrahydrofuran and dioxane. The resultant crude product was diluted with 300 ml of a 20% methylene chloride in pentane solution and passed through a 15 gram column of silica gel using a 50% solution of methylene chloride in pentane as eluant. The collected solution was again placed on the rotoevaporator to remove solvent and the resultant clear oil was placed under vacuum (<0.1 mm Hg) at 50° C. for four hours. The resulting octafluoro functionalized side-chain siloxane was a viscous, clear fluid. The yield was 65%. The described synthesis of a methacrylate end-capped fluoro-substituted side-chain siloxane is further illustrated in Scheme 3 below.

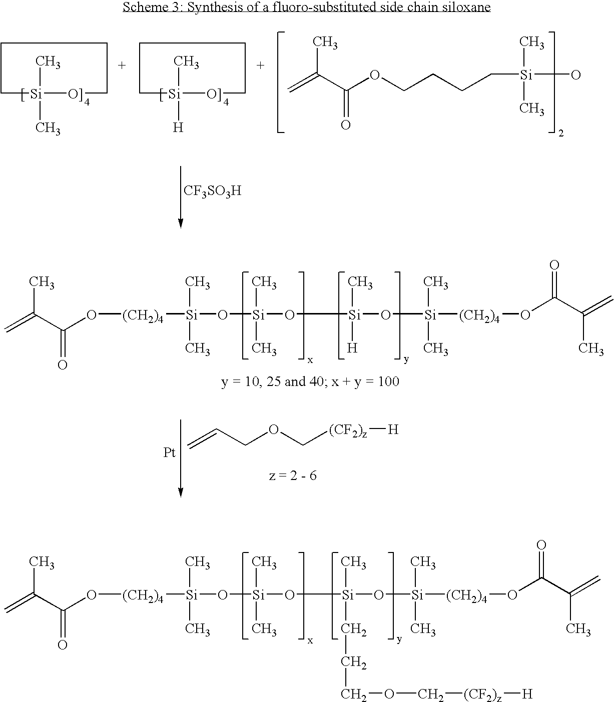

### EXAMPLE 6

### Film Preparation of a Photochromic Fluorosilicone Hydrogel

To 70 parts of the fluoro-substituted side-chain siloxane prepared in Example 5 are added 30 parts of N,N-dimethylacrylamide, 20 parts of hexanol, 0.5% Vazo® 64 (2,2′-azobisisobutyronitrile, available from DuPont Chemical, Wilmington, Del.) as the thermal polymerization initiator, and 0.5 mg/ml of the naphthopyran of Example 2. The clear solution is sandwiched between two silanized glass plates using metal gaskets and polymerized by heating at 60° C. for about 1 hour, 80° C. for about 1 hour, and 100° C. for about 1 hour. The resultant films are released and extracted in isopropanol (IPA) for four hours, followed by air-drying and a 30 mm vacuum to remove the IPA. The resultant films are hydrated at room temperature overnight in borate buffered saline. The photochromic property of the films can be tested in a similar manner as in Example 2.

### EXAMPLE 7

### Film Preparation of a Photochromic Silicone Polymer

To 100 parts of a vinyl terminated polymethylphenylsiloxane containing a platinum complex (called Med 6-6218, Part A), available commercially from Nusil, Carpinteria, Calif., were added 10 parts of a hydride containing polydimethylsiloxane (called Med 6-6218, Part B), available commercially from Nusil, and 0.5 mg/ml of the naphthopyran of Example 2. The viscous fluid was sandwiched between two silanized glass plates using metal gaskets and exposed to four hours of heat (125° C.). The resultant films were released and extracted in isopropanol (IPA) for four hours, followed by air-drying and a 30 mm vacuum to remove the IPA. The resultant films were placed at room temperature overnight in borate buffered saline. The clear tack-free films possessed a modulus of 300 g/mm² and a refractive index of 1.43. The films were exposed to the same blue light source as that of Example 2 for 1 minute. The film darkened at approximately one minute of blue light exposure (32° C.) and returned to its substantially colorless state within about 4 minutes after the blue light source was removed.

### EXAMPLE 8

### Film Preparation of Photochromic Hydrogel Acrylic Composition

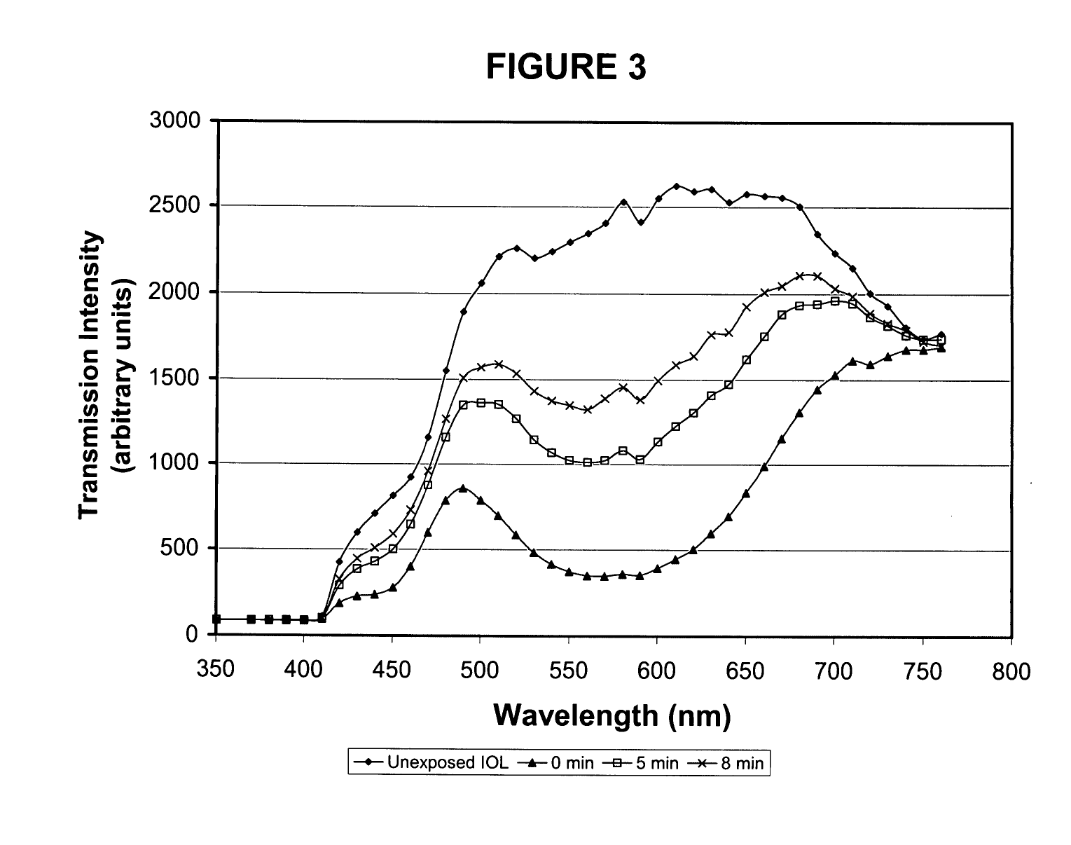

The following mixture was thoroughly blended together: 79.48% 2-hydroxyethyl methacrylate, 19.85% methyl methacrylate, 0.495% 2,2′-azobisisobutyronitrile, and 0.18% ethylene glycol dimethacrylate. The mixture was placed in IOL molds with simple flat covers and cured using a vacuum thermal oven purged with nitrogen. The temperature was allowed to rise to 85° C. and then held for about 30 minutes. The oven was turned off and the IOL buttons were allowed to cool slowly to room temperature. The cured IOL buttons had a thickness of about 200 micrometers. An IOL was tested for its photochromic property using the same blue light source as that of Example 2. The transmission spectrum of this IOL is shown in FIG. 3.

Soft, foldable polymeric compositions of the present invention having relatively high refractive index of approximately 1.42 or greater are synthesized using one or more photochromic materials and one or more polymerizable monomers, oligomers and/or prepolymers. To produce the subject polymeric compositions, one or more photochromic materials and one or more polymerizable monomers, oligomers and/or prepolymers are polymerized with optionally one or more strengthening agents added to enhance the mechanical properties of the polymeric compositions, one or more crosslinking agents and/or one or more catalysts.

Suitable strengthening agents include for example but are not limited to silica filler or an organosilicon resin such as for example a Q-resin with multiple vinyl groups. Other non-limiting examples of strengthening agents are the cycloalkyl acrylates and methacrylates, such as t-butylcyclohexyl methacrylate, isopropylcyclopentyl acrylate, isobornyl acrylate, isobornyl methacrylate, dicyclopentadienyl acrylate, dicyclopentadienyl methacrylate, adamantyl acrylate, adamantyl methacrylate, isopinocampheyl acrylate, and isopinocampheyl methacrylate.

Non-limiting suitable crosslinking agents include poly(dimethyl-co-methylhydrosiloxane), α,ω-bismethacryloxypropyl polydimethylsiloxane, ethylene glycol dimethacrylate (“EGDMA”), trimethylolpropane trimethacrylate (“TMPTMA”), glycerol trimethacrylate, polyethylene glycol dimethacrylate (wherein the polyethylene glycol preferably has a molecular weight up to, e.g., about 5000), and other polyacrylate and polymethacrylate esters, such as the end-capped polyoxyethylene polyols containing two or more terminal methacrylate moieties. Cyclic polyols with polyalkylether segments and curable segments can also be used. The crosslinking agents are used in the usual amounts, e.g., from about 0.0001 to about 0.02 mole per 100 grams of reactive components in the reaction mixture. (The reactive components are everything in the reaction mixture except the diluent and any additional processing aids which do not become part of the structure of the polymer.) Examples of hydrophilic monomers which can act as the crosslinking agent and when present do not require the addition of an additional crosslinking agent to the reaction mixture include polyoxyethylene polyols containing two or more terminal methacrylate moieties.

One class of suitable catalysts includes thermal polymerization initiators that are capable of generating free radicals at moderately elevated temperatures. Non-limiting examples of such catalysts include lauroyl peroxide, benzoyl peroxide, isopropyl percarbonate, 2,2′-azobisisobutyronitrile, 2,2′-azobis(2-methylbutyronitrile), and 2,2′-azobis(2,4-dimethylpentanenitrile). Other catalysts are photoinitiators such as acetophenone, benzophenone, anthraquinone, α-hydroketones (such as 2-hydroxy-2-methyl-1-phenyl-1-propanone, 1-hydroxy-cylohexyl-phenyl-ketone, 2-hydroxy-1-[4-(2-hydroxyethoxy)phenyl]-2-methyl-1-propanone), α-aminoketones (such as 2-benzyl-2-(dimethylamino)-1-[4-(4-morpholinyl)phenyl]-1-butanone, 2-methyl-1-[4-methylthio)phenyl]-2-(4-morpholinyl)-1-propanone), phosphine oxides (such as bis(2,4,6-trimethyl benzoyl) phenyl oxide), a combination of camphorquinone and ethyl 4-(N,N-dimethylamino)benzoate, and the metallocenes. The catalyst is used in the reaction mixture in catalytically effective amounts; e.g., from about 0.1 to about 2 parts by weight per 100 parts of reactive monomer.

Furthermore, one or more suitable ultraviolet radiation absorbers advantageously can be included in the subject photochromic polymeric compositions to impart a capability of filtering at least a portion of light in the wavelength range from UV to blue. Non-limiting examples of such ultraviolet radiation absorbers include 2-[3′-tert-butyl-5′-(3″-dimethylvinylsilylpropoxy)-2′-hydroxyphenyl]-5-methoxybenzotriazole or 2-(3′-allyl-2′-hydroxy-5′-methylphenyl)benzotriazole.

Such ultraviolet radiation-absorbing monomers can be provided in polymerizable embodiments to be chemically incorporated in the host polymer. Non-limiting examples of such materials include benzotriazole (meth)acrylate esters; e.g., 2-(2′-hydroxy-5′-acryloyloxyalkylphenyl)-2H-benzotriazoles; 2-(2′-hydroxy-5′-acryloyloxy-alkoxyphenyl)-2H-benzotriazoles; 2-(2′-hydroxyphenyl-5-acryloylalkoxy)benzotriazoles; 2-(2′-hydroxy-5′-methacryloxyethyl-phenyl)-2H-benzotriazole; 2-(2′-hydroxy-5′-methacryloxyethyl-phenyl)-5-chloro-2H-benzotriazole; 2-(2′-hydroxy-5′-methacryloxy-propylphenyl)-5-chloro-2H-benzotriazole; 2-(2′-hydroxy-5′-methacryloxypropyl-3′-tert-butylphenyl)-2H-benzotriazole-; 2-(2′-hydroxy-5′-methacryloxypropyl-3′-tert-butylphenyl)-5-chloro-2H-benzotriazole; 2-[2′-hydroxy-5′-(2-methacryloyloxyethoxy)-3′-tert-butylphenyl]-5-methoxy-2H-benzotriazole; 2-[2′-hydroxy-5′-(γ-methacryloyloxypropyloxy)-3′-tert-butylphenyl]-5-methoxy-2H-benzotriazole; 2-(3′-t-butyl-2′-hydroxy-5′-methoxyphenyl)-5-(3′-methacryloyloxypropoxy)benzotriazole, or mixtures thereof.

The photochromic polymeric compositions produced in a method of the present invention have refractive indices of approximately 1.38 or greater, relatively low glass transition temperatures of approximately 30° C. The photochromic polymeric compositions with the desirable physical properties described herein are particularly useful in the manufacture of ophthalmic devices such as but not limited to intraocular lenses (IOLs), contact lenses and corneal inlays due to the capability of absorbing blue light.

The relatively high refractive indices of the present photochromic polymeric compositions enable the manufacture of IOLs with thin optic portions. IOLs having thin optic portions are very desirable in enabling a surgeon to minimize surgical incision size. Keeping the surgical incision size to a minimum reduces intraoperative trauma and postoperative complications. A thin IOL optic portion is also very desirable for accommodating certain anatomical locations in the eye such as the anterior chamber and the ciliary sulcus. IOLs may be placed in the anterior chamber for increasing visual acuity in both aphakic and phakic eyes and placed in the ciliary sulcus for increasing visual acuity in phakic eyes.

The photochromic polymeric compositions produced as described herein have the flexibility desirable to allow ophthalmic devices manufactured from the same to be folded or deformed that can be inserted into an eye through the smallest possible surgical incision, i.e., 3.5 mm or smaller. It is unexpected that the subject photochromic polymeric compositions described herein could possess the ideal physical and photochromic characteristics disclosed herein. Specifically, the polymeric photochromic compositions can be activated by blue light (for example light having wavelengths in the range from about 400 nm to about 450 nm) and, in the activated state, can still further absorb some amount of blue light.

Ophthalmic medical devices produced using photochromic polymeric compositions produced in accordance with the present invention may be manufactured using methods known to those skilled in the art of the specific ophthalmic device being produced. For example, if an intraocular lens is to be produced, the same may be manufactured by methods known to those skilled in the art of intraocular lens production.

Ophthalmic medical devices such as but not limited to IOLs and corneal inlays manufactured using photochromic polymeric compositions of the present invention can be of any design capable of being rolled or folded for implantation through a relatively small surgical incision, i.e., 3.5 mm or less. For example, intraocular implants such as IOLs typically comprise an optic portion and one or more haptic portions. The optic portion reflects light onto the retina and the permanently attached haptic portions hold the optic portion in proper alignment within an eye following implantation. The haptic portions may be integrally formed with the optic portion in a one-piece design or attached by staking, adhesives or other methods known to those skilled in the art in a multipiece design.

The subject ophthalmic medical devices, such as IOLs, may be manufactured to have an optic portion and haptic portions made of the same or differing materials. In one aspect, both the optic portion and the haptic portions of the IOLs are made of the same photochromic polymeric composition of the present invention. Alternatively however, the IOL optic portion and haptic portions may be manufactured from two or more different materials and/or different formulations of polymeric compositions of the present invention, such as described in detail in U.S. Pat. Nos. 5,217,491 and 5,326,506, each incorporated herein in their entirety by reference. Once the materials are selected, the same may be cast in molds of the desired shape, cured and removed from the molds. After such molding, the IOLs are then cleaned, polished, packaged and sterilized by customary methods known to those skilled in the art. Alternatively, rather than molding, the IOLs may be manufactured by casting said polymeric composition in the form of a rod; lathing or machining said rod into disks; and lathing or machining said disks into an ophthalmic device prior to cleaning, polishing, packaging and sterilizing the same.

In addition to IOLs, photochromic polymeric compositions of the present invention are also suitable for use in the production of other ophthalmic devices such as contact lenses, keratoprostheses, capsular bag extension rings, corneal inlays, corneal rings, and like devices.

Ophthalmic medical devices manufactured using photochromic polymeric compositions of the present invention are used as customary in the field of ophthalmology. For example, in a surgical cataract procedure, an incision is placed in the cornea of an eye. Through the corneal incision the cataractous natural lens of the eye is removed (aphakic application) and an IOL is inserted into the anterior chamber, posterior chamber or lens capsule of the eye prior to closing the incision. However, the subject ophthalmic devices may likewise be used in accordance with other surgical procedures known to those skilled in the field of ophthalmology.

While the present disclosure show and describe various photochromic polymeric compositions, processes for producing the same, and ophthalmic medical devices made from such compositions, it will be manifest to those skilled in the art that various modifications may be made without departing from the spirit and scope of the underlying inventive concept and that the same is not limited to particular processes and structures herein shown and described except insofar as indicated by the scope of the appended claims.

What is claimed is:

1. A photochromic ophthalmic device comprising a polymeric composition that becomes photochromic upon being exposed to a portion of blue light having a first wavelength range, and is thereby activated and is capable of absorbing another portion of blue light having a second wavelength range.

2. The photochromic ophthalmic device of claim 1, wherein the polymeric composition comprises a photochromic material incorporated into a polymeric host, the photochromic material is activatable by the blue light having the first wavelength range.

3. The photochromic ophthalmic device of claim 1, wherein the polymeric composition further comprises an ultraviolet radiation absorbing material.

4. The photochromic ophthalmic device of claim 3, wherein the photochromic material is selected from the group consisting of naphthopyrans, benzopyrans, indenonaphthopyrans, phenanthropyrans, anthracene-fused pyrans, tetracene-fused pyrans, spiropyrans, oxazines, spiro(indoline)naphthoxazines, spiro(indoline)pyridobenzoxazines, spiro(benzindoline)pyridobenzoxazines, spiro(benzindoline)naphthoxazines, spiro(indoline)benzoxazines; mercury dithizonates, fulgides, fulgimides, derivatives thereof, and combinations thereof.

5. The photochromic ophthalmic device of claim 4, wherein the photochromic material comprises at least a reactive functional group that is capable of forming a covalent bond with a complementary reactive functional group of a precursor of the polymeric host.

6. The photochromic ophthalmic device of claim 3, wherein the photochromic material is selected from the group consisting of 2H-napthopyrans, 3H-naphthopyrans, derivatives thereof, and combinations thereof.

7. The photochromic ophthalmic device of claim 6, wherein the photochromic material is selected from the group consisting of 2,2-diphenyl-5-hydroxy-6-carboethoxy-2H-naphtho[1,2-b]pyran; 2,2-diphenyl-5-methoxy-6-carboethoxy-2H-naphtho[1,2-b]pyran; 2,2-diphenyl-5-hydroxy-6-morpholinocarbonyl-2H-naphtho[1,2-b]pyran; 2,2-diphenyl-5-morpholino-6-carboethoxy-2H-naphtho[1,2-b]pyran; 2,2,5-triphenyl-6-carboethoxy-2H-naphtho[1,2-b]pyran; 2-(4-methoxyphenyl)-2-(4-morpholinophenyl)-5-hydroxy-6-carboethoxy-2H-naphtho[1,2-b]pyran; 2,2-diphenyl-5-hydroxy-6-carbomethoxy-9-methoxy-2H-naphtho[1,2-b]pyran; 2-(4-methoxyphenyl)-2-phenyl-5-morpholino-6-carbomethoxy-9-methoxy-2H-naphtho[1,2-b]pyran; and 2-(4-methoxyphenyl)-2-phenyl-5-morpholino-6-carbomethoxy-9-methyl-2H-naphtho[1,2-b]pyran; 3,3-diphenyl-3H-naphtho[2,1,b]pyran; 3-phenyl-3-(4-methoxyphenyl)-3H-naphtho[2,1,b]pyran; 3-phenyl-3-(4-trifluoromethylphenyl)-3H-naphtho[2,1,b]pyran; 3,3-di(4-methoxyphenyl)-3H-naphtho[2,1,b]pyran; 3-(4-methoxyphenyl)-3-(4-trifluoromethylphenyl)-3H-naphtho[2,1,b]pyran; 3,3-di(4-methoxyphenyl)-6-piperidino-3H-naphtho[2,1,b]pyran; 3,3-di(4-methoxyphenyl)-6-morpholino-3H-naphtho[2,1,b]pyran; derivatives thereof; and combinations thereof.

8. The photochromic ophthalmic device of claim 7, wherein the photochromic material further comprises a reactive functional group selected from the group consisting of vinyl, allyl, acryloyl, acryloyloxy, methacryloyl, methacryloyloxy, acrylamido, methacrylamido, itaconoyl, fumaroyl, maleimido, epoxide, isocyante, amino, hydroxy, alkoxy, mercapto, anhydride, carboxylic, and combinations thereof.

9. The photochromic ophthalmic device of claim 3, wherein the polymeric host is selected from the group consisting of polysiloxanes, silicone hydrogels, fluorosilicone hydrogels, polyacrylamides, polymethacrylamides, polycarbonates, polycarbamates, fluoropolymers, polyolefins, polyacrylates, polymethacrylates, poly(acrylic acid), poly(methacrylic acid), polyurethanes, polythiourethanes, thermoplastic polycarbonates, polyesters, poly(ethylene terephthalate), polystyrene, poly(a-methylstyrene), copoly(styrene-methyl methacrylate), copoly(styrene-acrylonitrile), polyvinylbutyral, poly(vinyl acetate), cellulose acetate, cellulose propionate, cellulose butyrate, cellulose acetate butyrate, copolymers thereof, and mixtures thereof.

10. The photochromic ophthalmic device of claim 3, wherein the polymeric host material further comprises units of a crosslinking agent.

11. The photochromic ophthalmic device of claim 3, wherein absorption spectra of the photochromic polymeric composition in an unactivated state and an activated state are substantially the same for wavelengths shorter than about 400 nm.

12. The photochromic ophthalmic device of claim 11, wherein the ophthalmic device is an intraocular lens.

13. The photochromic ophthalmic device of claim 11, wherein the ophthalmic device is a corneal inlay.

14. The photochromic ophthalmic device of claim 11, wherein the ophthalmic device is a contact lens.

15. A photochromic ophthalmic device comprising a polymeric composition that is photochromic upon being exposed to at least a portion of blue light having a first wavelength range and is thereby capable of absorbing another portion of blue light having a second wavelength range;
wherein the polymeric composition comprises a photochromic material, a crosslinking agent, and an ultraviolet radiation absorbing material, incorporated into a polymeric host; the photochromic material is selected from the group consisting of 2H-napthopyrans, 3H-naphthopyrans, derivatives thereof, and combinations thereof and comprises at least a first reactive functional group that is capable of forming a covalent bond with a second reactive functional group of a precursor of the polymeric host; and
wherein the polymeric host is selected from the group consisting of polysiloxanes, polyacrylates, polymethacrylates, polyacrylamides, polymethacrylamides, polycarbonates, polycarbamates, fluoropolymers, polyolefins, hydrogel polymers, and combinations thereof.

16. A photochromic polymeric composition comprising a photochromic material incorporated into a polymeric host, the photochromic polymeric composition being activatable by blue light having a first wavelength range to become photochromic, and thereby being capable of absorbing another portion of blue light having a second wavelength range.

17. The photochromic polymeric composition of claim 16, wherein the polymeric composition further comprises an ultraviolet radiation-absorbing material.

18. The photochromic polymeric composition of claim 17, wherein the photochromic material is selected from the group consisting of naphthopyrans, benzopyrans, indenonaphthopyrans, phenanthropyrans, anthracene-fused pyrans, tetracene-fused pyrans, spiropyrans, oxazines, spiro(indoline)naphthoxazines, spiro(indoline)pyridobenzoxazines, spiro(benzindoline)pyridobenzoxazines, spiro(benzindoline)naphthoxazines, spiro(indoline)benzoxazines; mercury dithizonates, fulgides, fulgimides, derivatives thereof, and combinations thereof.

19. The photochromic polymeric composition of claim 17, wherein the photochromic material comprises at least a reactive functional group that is capable of forming a covalent bond with a complementary reactive functional group of the polymeric host.

20. The photochromic polymeric composition of claim 19, wherein the photochromic material is selected from the group consisting of 2H-napthopyrans, 3H-naphthopyrans, derivatives thereof, and combinations thereof.

21. The photochromic polymeric composition of claim 20, wherein the photochromic material is selected from the group consisting of 2,2-diphenyl-5-hydroxy-6-carboethoxy-2H-naphtho[1,2-b]pyran; 2,2-diphenyl-5-methoxy-6-carboethoxy-2H-naphtho[1,2-b]pyran; 2,2-diphenyl-5-hydroxy-6-morpholinocarbonyl-2H-naphtho[1,2-b]pyran; 2,2-diphenyl-5-morpholino-6-carboethoxy-2H-naphtho[1,2-b]pyran; 2,2,5-triphenyl-6-carboethoxy-2H-naphtho[1,2-b]pyran; 2-(4-methoxyphenyl)-2-(4-morpholinophenyl)-5-hydroxy-6-carboethoxy-2H-naphtho[1,2-b]pyran; 2,2-diphenyl-5-hydroxy-6-carbomethoxy-9-methoxy-2H-naphtho[1,2-b]pyran; 2-(4-methoxyphenyl)-2-phenyl-5-morpholino-6-carbomethoxy-9-methoxy-2H-naphtho[1,2-b]pyran; and 2-(4-methoxyphenyl)-2-phenyl-5-morpholino-6-carbomethoxy-9-methyl-2H-naphtho[1,2-b]pyran; 3,3-diphenyl-3H-naphtho[2,1,b]pyran; 3-phenyl-3-(4-methoxyphenyl)-3H-naphtho[2,1,b]pyran; 3-phenyl-3-(4-trifluoromethylphenyl)-3H-naphtho[2,1,b]pyran; 3,3-di(4-methoxyphenyl)-3H-naphtho[2,1,b]pyran; 3-(4-methoxyphenyl)-3-(4-trifluoromethylphenyl)-3H-naphtho[2,1,b]pyran; 3,3-di(4-methoxyphenyl)-6-piperidino-3H-naphtho[2,1,b]pyran; 3,3-di(4-methoxyphenyl)-6-morpholino-3H-naphtho[2,1,b]pyran; derivatives thereof; and combinations thereof.

22. The photochromic polymeric composition of claim 21, wherein the reactive functional group of the photochromic material is selected from the group consisting of vinyl, allyl, acryloyl, acryloyloxy, methacryloyl, methacryloyloxy, acrylamido,methacrylamido, itaconoyl, fumaroyl, maleimido, epoxide, isocyante, amino, hydroxy, alkoxy, mercapto, anhydride, carboxylic, and combinations thereof.

23. The photochromic polymeric composition of claim 17, wherein the polymeric host material is selected from the group consisting of polysiloxanes, polyacrylates, polymethacrylates, poly(acrylic acid), poly(methacrylic acid), polyurethanes, polythiourethanes, thermoplastic polycarbonates, polyesters, poly(ethylene terephthalate), polystyrene, poly(alpha methylstyrene), copoly(styrene-methyl methacrylate), copoly(styrene-acrylonitrile), polyvinylbutyral, poly(vinyl acetate), cellulose acetate, cellulose propionate, cellulose butyrate, cellulose acetate butyrate, copolymers thereof, and mixtures thereof.

24. The photochromic polymeric composition of claim 17, wherein the polymeric host material further comprises units of a crosslinking agent.

25. The photochromic polymeric composition of claim 17, wherein absorption spectra of the photochromic polymeric composition in an unactivated state and an activated state are substantially the same for wavelengths shorter than about 400 nm.

26. A photochromic polymeric composition comprising a photochromic material and an ultraviolet radiation absorbing material, both incorporated into a polymeric host, the photochromic polymeric composition being activatable to become photochromic by blue light having a first wavelength range and thereby capable of absorbing another portion of blue light having a second wavelength range; the photochromic material is selected from the group consisting of 2H-napthopyrans, 3H-naphthopyrans, derivatives thereof, and combinations thereof and comprises at least a first reactive functional group that is capable of forming a covalent bond with a second reactive functional group of a precursor of the polymeric host; wherein the polymeric host is selected from the group consisting of polysiloxanes, polyacrylates, polymethacrylates, hydrogel polymers, and combinations thereof; and wherein the photochromic material is covalently bonded to the polymeric host.

27. A method for producing a photochromic polymeric composition, the method comprising:
providing a photochromic material having at least a first reactive functional group;
providing a polymer precursor selected from the group consisting of monomers, oligomers, prepolymers, and combinations thereof; the polymer precursor having at least a second reactive functional group, which is capable of forming a covalent bond with the first reactive functional group; and
reacting the polymer precursor with the photochromic material to form the photochromic polymeric composition;
wherein the photochromic material is selected from the group consisting of naphthopyrans, benzopyrans, indenonaphthopyrans, phenanthropyrans, anthracene-fused pyrans, tetracene-fused pyrans, spiropyrans, oxazines, spiro(indoline)naphthoxazines, spiro(indoline)pyridobenzoxazines, spiro(benzindoline)pyridobenzoxazines, spiro(benzindoline)naphthoxazines, spiro(indoline)benzoxazines; mercury dithizonates, fulgides, fulgimides, derivatives thereof, and combinations thereof; and
wherein the photochromic polymeric composition is activatable by at least a portion of blue light having a first wavelength range and thereby capable of absorbing another portion of blue light having a second wavelength range.

28. The method of claim 27, further comprising providing an ultraviolet radiation-absorbing material, wherein the step of reacting comprises reacting the polymer precursor, the photochromic material, and the ultraviolet radiation-absorbing material.

29. The method of claim 28, wherein the photochromic material is selected from the group consisting of 2H-napthopyrans, 3H-naphthopyrans, derivatives thereof, and combinations thereof.

30. The method of claim 29, wherein absorption spectra of the photochromic polymeric composition in an unactivated state and an activated state are substantially the same for wavelengths less than about 400 nm.
